(19) United States
(12) Patent Application Publication
(10) Pub. No.: US 2016/0066764 A1
(43) Pub. Date: Mar. 10, 2016

(54) METHOD AND DEVICE FOR WRINGING A MOP

(71) Applicant: POWERWRING INC., Toronto (CA)

(72) Inventors: Noah Nuoxu Yang, Edmonton (CA); Ryan Stewart Williams, Scarborouogh (CA); Shuyi Wu, Winnipeg (CA); Jeremy Chan-Hao Wang, Scarborough (CA)

(73) Assignee: POWERWRING INC., Toronto (CA)

(21) Appl. No.: 14/681,157

(22) Filed: Apr. 8, 2015

Related U.S. Application Data
(60) Provisional application No. 62/048,332, filed on Sep. 10, 2014.

(51) Int. Cl. A47L 13/59; F16B 7/04

(52) U.S. Cl. CPC A47L 13/59; F16B 7/0486

(57) ABSTRACT

A wringer connector for connecting a mop handle to a lever of a mop wringer to allow the mop handle to actuate the lever. The wringer connector comprises a first connector securable to one of the lever and the mop handle and engageable with the one of the lever and the mop handle to rotationally fix the first connector with respect to the one of the lever and the mop handle; and a second connector extending from the first connector and engageable with the other of the lever and the mop handle to functionally connect the mop handle to the lever.

### CROSS-REFERENCES TO RELATED APPLICATIONS

This application claims priority from U.S. provisional patent application 62/048,332, filed on Sep. 10, 2014, which is incorporated herein by reference in its entirety.

### FIELD

The disclosure relates to mop wringers, and more particularly to a wringer connector for connecting a mop handle to a lever of a mop wringer, to allow the mop handle to actuate the lever.

### BACKGROUND

U.S. Pub. No. 2006/0277709 (Young) purports to disclose a mop wringer comprising a basket having an opening for accepting a mophead having mop material to be wrung, a lever-operated mechanically assisted pressing mechanism including a press member for pressing the mop material of the mophead into or against the basket, and an elongate lever for operating the press member. The lever is positioned in a plane which bisects or substantially bisects the opening of the basket. There is also provided a mop holding element specifically adapted for a centralised lever of a mop wringer as described above. The holding element comprises a means for securing the holding element to the lever of the wringer, and a gripping portion for releasably gripping a mop handle attached to the mophead.

U.S. Pat. No. 559,093 (Wolff) purports to disclose a mop-wringer consisting of a perforated or foraminous vessel composed of telescopic sections whereby the capacity of the vessel may be increased to receive the mop and decreased to compress it, and means actuated by the handle of the mop for causing one of said sections to slide within the other.

U.S. Pat. No. 2,851,710 purports to disclose a mop and wringing attachment that reduces the wringing effort required by providing a high mechanical advantage that utilizes the mop handle in providing this high mechanical advantage and thereby eliminates bending over during the wringing operation.

### SUMMARY

The following summary is intended to introduce the reader to various aspects of the applicant's teaching, but not to define any invention.

According to one aspect, a wringer connector for connecting a mop handle to a lever of a mop wringer is provided. The wringer connector allows the mop handle to actuate the lever. The wringer connector comprises a first connector securable to one of the lever and the mop handle, and engageable with the one of the lever and the mop handle to rotationally fix the first connector with respect to the one of the lever and the mop handle. A second connector extends from the first connector and is engageable with the other of the lever and the mop handle to functionally connect the mop handle to the lever.

In some examples, the first connector may be securable to the lever, and the second connector may be engageable with the mop handle. The first connector may comprise a resiliently flexible sleeve positionable around the lever, and a clamp positionable around the sleeve and tightenable to frictionally rotationally fix the first connector with respect to the lever.

In some examples, the resiliently flexible sleeve may be a rubber sleeve. The rubber sleeve may comprise a longitudinally extending slit extending through a wall thickness thereof. The rubber sleeve may be openable at the slit to allow the rubber sleeve to be positioned around the lever.

In some examples, the clamp may include at least two clamp portions. The clamp portions may be securable together around the resiliently flexible sleeve.

In some examples, the second connector may be integral with the clamp. The second connector may comprise an arm extending generally orthogonally from the first connector. The arm may comprise an abutment surface for contacting the mop handle and which the mop handle may be forced against to actuate the lever.

According to another aspect, a mop wringing assembly is provided. The mop wringing assembly includes a mop wringer having a press for wringing a mop and a lever for actuating the press. A wringer connector is provided for connecting a mop handle to the lever to allow the mop handle to actuate the lever. The wringer connector comprises a first connector secured to one of the lever and the mop handle and rotationally fixed to the one of the lever and the mop handle, and a second connector extending from the first connector and engageable with the other of the lever and the mop handle to functionally connect the mop handle to the lever.

In some examples, the first connector may be secured to the lever, and the second connector may be engageable with the mop handle. The first connector may comprise a resiliently flexible sleeve positionable around the lever, and a clamp positionable around the sleeve and tightenable to frictionally rotationally fix the first connector with respect to the lever.

The resiliently flexible sleeve may be a rubber sleeve. The rubber sleeve may comprise a longitudinally extending slit extending through a wall thickness thereof. The rubber sleeve may be openable at the slit to allow the rubber sleeve to be positioned around the lever.

In some examples, the clamp may include at least two clamp portions. The clamp portions may be securable together around the resiliently flexible sleeve.

In some examples, the second connector may be integral with the clamp. The second connector may comprise an arm extending generally orthogonally from the first connector. The arm may comprise an abutment surface for contacting the mop handle and which the mop handle may be forced against to actuate the lever.

According to another aspect, a method of wringing a mop is provided. The method may comprise a) securing a wringer connector to one of a lever of a mop wringer and a handle of the mop; b) inserting a head of the mop into a press of the mop wringer; c) engaging the other of the lever of the mop wringer and the handle of the mop with the wringer connector; and d) using the handle of the mop to rotate the lever and thereby actuate the press.

In some examples, step a) may comprise securing the wringer connector to the lever of the mop wringer.

In some examples, step d) may comprise forcing the handle of the mop against the wringer connector.

In some examples, step a) may comprise rotationally fixing the wringer connector to the lever of the mop wringer.

In some examples, step a) may comprise positioning a resiliently flexible sleeve around the lever, and tightening a clamp around the sleeve.

In some examples, step c) may comprise positioning the handle against an abutment surface of the wringer connector.

According to another aspect, a wringer connector is provided for connecting a mop handle to a lever of a mop wringer to allow the mop handle to actuate the lever. The wringer connector comprises a first connector securable to the lever and engageable with the lever to rotationally fix the first connector with respect to the lever. A second connector is securable to the mop handle and engageable with the mop handle to rotationally fix the second connector with respect to the mop handle. The second connector is removably securable to the first connector to functionally connect the mop handle to the lever.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1A is an isometric view of a mop wringing assembly including a mop wringer and a wringer connector, wherein the lever of the mop wringer is in a non-actuated position;

FIG. 1B is an isometric view of the mop wringing assembly of FIG. 1A, wherein the lever of the wringing assembly is in an actuated position;

FIG. 2 is an isometric view of the wringer connector shown in FIG. 1;

FIG. 3A is a front elevation view of the wringer connector of FIG. 2;

FIG. 3B is a cross-section taken along line B-B in FIG. 3A;

FIG. 3C is a cross-section taken along line C-C in FIG. 3A;

FIG. 3D is a cross-section taken along line D-D in FIG. 3A; and

FIGS. 4A to 4C are schematic cross-sectional drawings showing alternate examples of a wringer connector.

### DETAILED DESCRIPTION

Various apparatuses or processes will be described below to provide an example of an embodiment of the claimed subject matter. No embodiment described below limits any claim and any claim may cover processes or apparatuses that differ from those described below. The claims are not limited to apparatuses or processes having all of the features of any one apparatus or process described below or to features common to multiple or all of the apparatuses described below. It is possible that an apparatus or process described below is not an embodiment of any exclusive right granted by issuance of this patent application. Any invention disclosed in an apparatus or process described below and for which an exclusive right is not granted by issuance of this patent application may be the subject matter of another protective instrument, for example, a continuing patent application, and the applicants, inventors or owners do not intend to abandon, disclaim or dedicate to the public any such invention by its disclosure in this document.

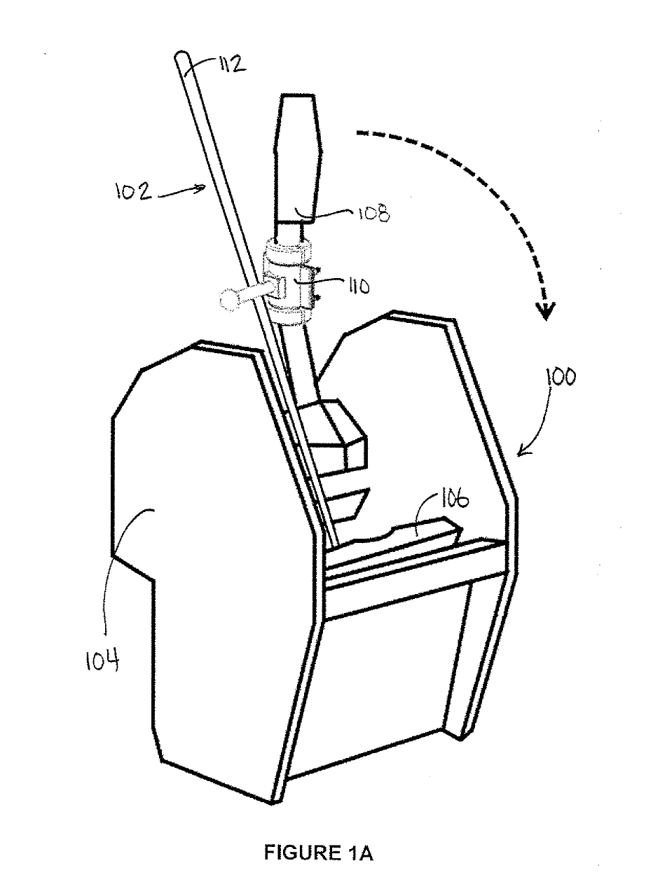

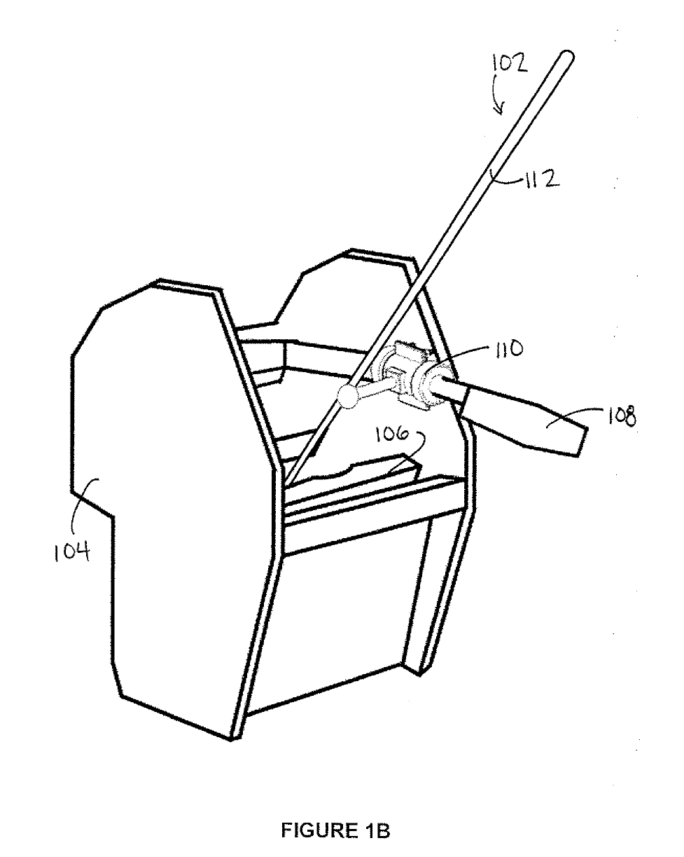

Reference is made to FIGS. 1A and 1B, which show an example mop wringing assembly 100 with a mop 102 inserted therein. The mop wringing assembly 100 includes a mop wringer 104 which may be of any suitable design, and which may be mounted to a mop bucket (not shown). In the example shown, the mop wringer 104 includes a press 106 for wringing the mop 102, and a lever 108 for actuating the press 106. The lever 108 is shown in a non-actuated position in FIG. 1A, and an actuated position in FIG. 1B. In the actuated position, the press 106 squeezes the mop head to wring the mop.

Referring still to FIGS. 1A and 1B, an example wringer connector 110 is mounted to the lever 108. The wringer connector 110 may be used to connect the handle 112 of the mop 102 (also referred to as mop handle 112) to the lever 108, to allow the mop handle 112 to actuate the lever 108. That is, the wringer connector 110 allows the user to use the mop handle 112 to rotate the lever 108 and thereby actuate the press 106, as shown in FIG. 1B. This may reduce or minimize the extent to which the user has to bend down to actuate the mop wringer 104.

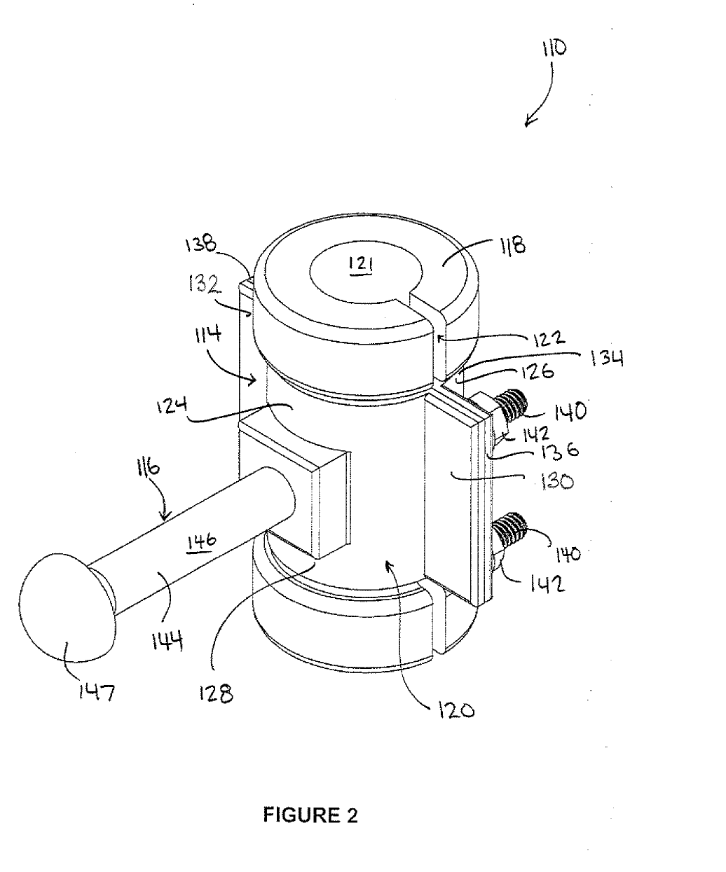

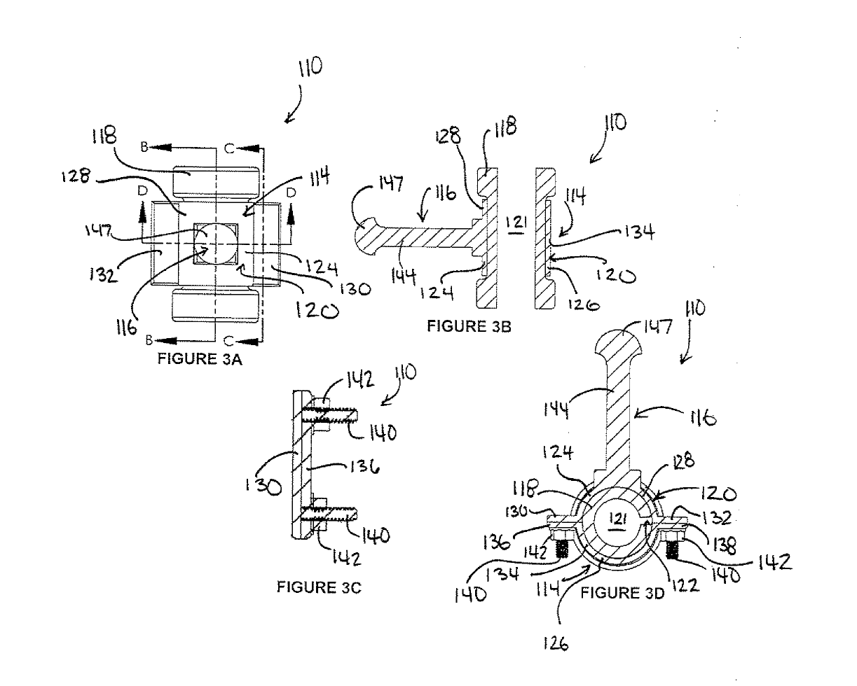

Reference is now made to FIGS. 2 and 3A-D. In the example shown, the wringer connector 110 includes a first connector 114 that is securable to the lever 108 and engageable with the lever 108 to rotationally fix the first connector 114 with respect to the lever 108. The wringer connector 110 further includes a second connector 116 extending from the first connector 114 and engageable with the mop handle 112, to functionally connect the mop handle 112 to the lever 108. As used herein, the term “rotationally fix” indicates that in use, when the mop handle 112 is forced against the wringer connector 110 to actuate the lever 108, the wringer connector 110 does not rotate with respect to the lever 108 about the longitudinal axis of the lever 108.

In the example shown, the first connector 114 includes a resiliently flexible sleeve 118 positionable around the lever 108, and a clamp 120 positionable around the sleeve 118 and tightenable to frictionally rotationally fix the first connector 114 with respect to the lever 108.

In the example shown, the resiliently flexible sleeve 118 is an elongate tube with a cylindrical lumen 121 for receiving the lever 108. The resiliently flexible sleeve 118 includes a longitudinally extending slit 122 extending through a wall thickness thereof, to permit the resiliently flexible sleeve 118 to be opened at the slit 122 and positioned around the lever 108.

The resiliently flexible sleeve 118 may for example be made from rubber, silicone, polyurethane, polyester, epoxy resin, phenolic resin, polyethylene, polypropylene, polyvinyl chloride, and/or combinations thereof

In some examples, the clamp 120 may include at least two clamp portions that are securable together around the resiliently flexible sleeve 118. In the example shown, the clamp 120 includes a first clamp portion 124 and a second clamp portion 126.

In the example shown, the first clamp portion 124 includes a first elongate half cylinder 128 with a pair of flanges 130, 132 extending from opposed edges thereof. The second clamp portion 126 includes a second elongate half cylinder 134 with a pair of flanges 136, 138 extending from opposed edges thereof. When the first 124 and second 126 clamp portions are assembled together, the flanges 130, 132 face the flanges 136, 138, respectively.

Fasteners may be provided for securing the first clamp portion 124 to the second clamp portion 126. In the example shown, the fasteners include a pair of threaded shafts 140 extending integrally from each flange 130, 132. The flanges 136, 138 each include a pair of apertures (not shown) for receiving the shafts 140. A nut 142 may be threaded onto each shaft 140 to tighten the clamp portions 124, 126 together, and thereby tighten the clamp 120 around the resiliently flexible sleeve 118, to frictionally rotationally fix the wringer connector 110 to the lever 108.

In other examples, the clamp portions 124, 126 may be secured together in another manner, such as by adhesives, welding, and riveting. In further alternate examples, the clamp portions 124, 126 may be joined together by a hinge.

In alternative examples, the first connector 114 may be rotationally fixed to the lever 108 in another manner. For example, the first connector 114 may be fixed to the lever with adhesives; magnets; and/or mechanical interlocking. For example, one or more holes may be drilled in the mop handle 112, and the first connector 114 may be bolted directly to the mop handle 112.

Referring still to FIGS. 2 and 3A to 3D, as mentioned above, the wringer connector 110 further includes a second connector 116 extending from the first connector 114 and engageable with the mop handle 112, to functionally connect the mop handle 112 to the lever 108. In the example shown, the second connector 116 includes an arm 144 extending generally orthogonally from the first clamp portion 124 of the first connector 114. The arm 144 includes an abutment surface 146 for contacting the mop handle 112, and against which the mop handle 112 may be forced to actuate the lever 108. A cap 147 is mounted at the distal end of the arm 144 to stop the mop handle 112 from slipping off of the arm 144. In use, the mop handle 112 may be engaged with the second connector 116 by contacting the mop handle 112 with the abutment surface 146 of the arm 144. The mop handle 112 may then be forced against the arm 144. As the first connector 114 is rotationally fixed to the lever 108, the force causes the lever 108 to rotate, and actuate the press 106.

In the example shown, the arm 144 extends generally orthogonally from the first clamp portion 124. In alternative examples, the arm may extend from the clamp at a non-orthogonal angle.

In the example shown, the arm 144 is integral with the clamp 120. In alternative examples, the arm 144 may be formed separately from the clamp 120.

In some examples, the first connector 114 and second connector 116 can be made from a stainless steel, such as Stainless Steel Grade 316 (UNS 31600). Other suitable materials include but are not limited to plastics, other metals or alloys such as aluminum, wood, or composite materials. Furthermore, the first connector 114 and/or the second connector 116 may include coatings such as anti-microbial coatings.

In some examples, the abutment surface 146 may be coated with a low-friction material, such as Teflon. Other friction-reducing techniques can also be used such as, but not limited to, incorporating rollers or bearings (not shown) into the abutment surface 146.

In the example shown, the wringer connector 110 is separately formed from the mop handle 112 and lever 108, and may therefore optionally be sold as a retrofit device for existing mop wringing assemblies 100. In alternative examples, the wringer connector 110 may be integrally formed with the lever 108 or the mop handle 112.

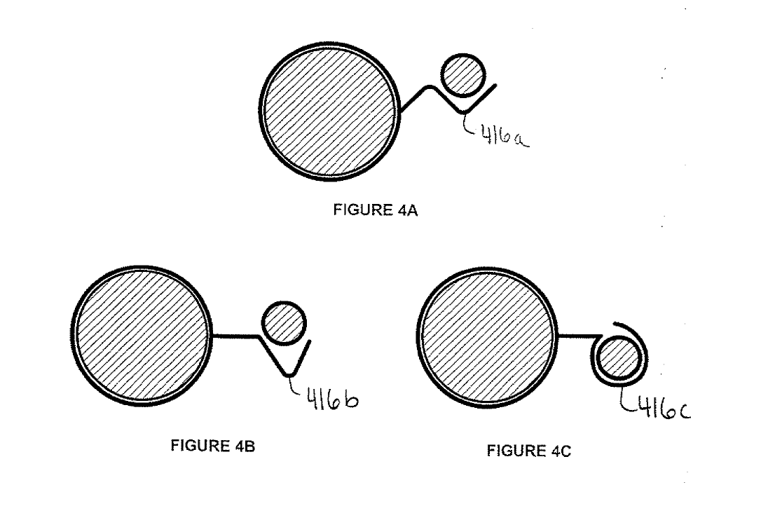

FIGS. 4A to 4C schematically show three alternative examples of a second connector, identified with numerals 416a, 416b, and 416c, in which the second connector is curved to prevent the mop handle 112 from laterally slipping off the second connector.

In the example shown, the wringer connector 110 is secured to the lever 108 by the first connector 114, and the mop handle 112 is engageable with the second connector 116 of the wringer connector 110. In alternative examples, the wringer connector 110 may be secured to the mop handle 112 by the first connector 114, and the lever 108 may be engageable with the second connector 116 of the wringer connector 110. That is, the first connector 114 can optionally be rotationally fixed to the mop handle 112 instead of the lever 108.

In an alternative example, the wringer connector may be provided in two separate pieces, one of which is connected to the lever, and one of which is connected to the mop handle. For example a lever connector may be provided as a separate piece from a mop connector. The lever connector may be secured to the lever, and the mop connector may be secured to the mop handle. The lever connector and mop connector may be removably securable together, for example, by a snap fit, a friction fit, or by simple abutment. In use, the lever connector may be connected to the mop connector, to connect the lever to the mop handle. The mop handle may then be used to rotate the lever.

An example method of wringing a mop 102 using wringer connector 110 will now be described. The example method includes securing the wringer connector 110 to the lever 108. For example, the resiliently flexible sleeve 118 may be opened at the slit 122, and fitted around the lever 108. The clamp portions 124, 126 may then be positioned around the resiliently flexible sleeve 118, and secured together and tightened, for example by tightening nuts 142. The head (not shown) of the mop 102 may then be inserted into the press 106, and the mop handle 112 may be engaged with the wringer connector 110. For example, the mop handle 112 may be positioned against the abutment surface 146. The mop handle 112 may then be used to rotate the lever 108, and thereby actuate the press 106. For example the mop handle 112 may be forced against the abutment surface 146 of the wringer connector 110 to rotate the lever 108.

In an alternative example, a method may include securing the wringer connector 110 to the mop handle 112. The wringer connector 110 may then be engaged with the lever 108, and the mop handle 112 may be used to rotate the lever 108 and thereby actuate the press 106. For example, the second connector 116 of the wringer connector 110 may be forced against the lever 108.

1. A wringer connector for connecting a mop handle to a lever of a mop wringer to allow the mop handle to actuate the lever, the wringer connector comprising:
a) a first connector securable to one of the lever and the mop handle and engageable with the one of the lever and the mop handle to rotationally fix the first connector with respect to the one of the lever and the mop handle;
b) a second connector extending from the first connector and engageable with the other of the lever and the mop handle to functionally connect the mop handle to the lever.

2. The wringer connector of claim 1, wherein the first connector is securable to the lever, and the second connector is engageable with the mop handle.

3. The wringer connector of claim 2, wherein the first connector comprises a resiliently flexible sleeve positionable around the lever, and a clamp positionable around the sleeve and tightenable to frictionally rotationally fix the first connector with respect to the lever.

4. The wringer connector of claim 3, wherein the resiliently flexible sleeve comprises a longitudinally extending slit extending through a wall thickness thereof, the resiliently flexible sleeve openable at the slit to allow the resiliently flexible sleeve to be positioned around the lever.

5. The wringer connector of claim 3, wherein the clamp includes at least two clamp portions, the clamp portions securable together around the resiliently flexible sleeve.

6. The wringer connector of claim 3 wherein the second connector is integral with the clamp.

7. The wringer connector of claim 1, wherein the second connector comprises an arm extending generally orthogonally from the first connector, and the arm comprises an abutment surface for contacting the mop handle and which the mop handle may be forced against to actuate the lever.

8. A mop wringing assembly comprising:
a) a mop wringer comprising a press for wringing a mop, and a lever for actuating the press;
b) a wringer connector for connecting a mop handle to the lever to allow the mop handle to actuate the lever, the wringer connector comprising a first connector secured to one of the lever and the mop handle and rotationally fixed to the one of the lever and the mop handle, and a second connector extending from the first connector and engageable with the other of the lever and the mop handle to functionally connect the mop handle to the lever.

9. The mop wringing assembly of claim 8, wherein the first connector is secured to the lever, and the second connector is engageable with the mop handle.

10. The mop wringing assembly of claim 9, wherein the first connector comprises a resiliently flexible sleeve positionable around the lever, and a clamp positionable around the sleeve and tightenable to frictionally rotationally fix the first connector with respect to the lever.

11. The mop wringing assembly of claim 10, wherein the resiliently flexible sleeve comprises a longitudinally extending slit extending through a wall thickness thereof, the resiliently flexible sleeve openable at the slit to allow the resiliently flexible sleeve to be positioned around the lever.

12. The mop wringing assembly of claim 11, wherein the clamp includes at least two clamp portions, the clamp portions securable together around the resiliently flexible sleeve.

13. The mop wringing assembly of claim 11, wherein the second connector is integral with the clamp.

14. The mop wringing assembly of claim 10, wherein the second connector comprises an arm extending generally orthogonally from the first connector, and the arm comprises an abutment surface for contacting the mop handle and which the mop handle may be forced against to actuate the lever.

15. A method of wringing a mop, the method comprising:
a) securing a wringer connector to one of a lever of a mop wringer and a handle of the mop;
b) inserting a head of the mop into a press of the mop wringer;
c) engaging the other of the lever of the mop wringer and the handle of the mop with the wringer connector; and
d) using the handle of the mop to rotate the lever and thereby actuate the press.

16. The method of claim 15, wherein step a) comprises securing the wringer connector to the lever of the mop wringer.

17. The method of claim 15, wherein step d) comprises forcing the handle of the mop against the wringer connector.

18. The method of claim 15, wherein step a) comprises:
a) rotationally fixing the wringer connector to the lever of the mop wringer.

19. The method of claim 18 wherein step a) comprises positioning a resiliently flexible sleeve around the lever, and tightening a clamp around the sleeve.

20. The method of claim 15, wherein step c) comprises positioning the handle against an abutment surface of the wringer connector.

21. A wringer connector for connecting a mop handle to a lever of a mop wringer to allow the mop handle to actuate the lever, the wringer connector comprising:
a) a first connector securable to the lever and engageable with the lever to rotationally fix the first connector with respect to the lever;
b) a second connector securable to the mop handle and engageable with the mop handle to rotationally fix the second connector with respect to the mop handle, the second connector removably securable to the first connector to functionally connect the mop handle to the lever.
